(19) United States
(12) Patent Application Publication
(10) Pub. No.: US 2025/0271626 A1
(43) Pub. Date: Aug. 28, 2025

(54) OPTICAL MODULE WITH COMPACT ARRANGEMENT BY HEIGHT DIFFERENCE BETWEEN COMPONENTS

(71) Applicant: Prime World International Holdings Ltd., New Taipei City (TW)

(72) Inventors: Yu CHEN, New Taipei City (TW); Che-Shou YEH, New Taipei City (TW); Ming-You LAI, New Taipei City (TW); Hsuan-Chen SHIU, New Taipei City (TW)

(21) Appl. No.: 18/755,084

(22) Filed: Jun. 26, 2024

(30) Foreign Application Priority Data
Feb. 23, 2024 (TW) 113106483

(51) Int. Cl. G02B 6/42

(52) U.S. Cl. CPC G02B 6/4202

(57) ABSTRACT

An optical module, including housing, at least one optical coupler, motherboard, daughter board, first transmitting optical assembly, second transmitting optical assembly, receiver optical assembly, at least one first inner optical fiber, at least one second inner optical fiber, and third inner optical fibers. At least one optical coupler is disposed within housing. Motherboard is disposed in housing. Daughter board is disposed in housing and disposed on mounting surface of motherboard. First transmitting optical assembly is disposed on mounting surface of motherboard. Second transmitting optical assembly is disposed on mounting surface of daughter board, and mounting surface and mounting surface of motherboard face identical direction. Receiver optical assembly is disposed on mounting surface of motherboard. At least one first inner optical fiber optically couples first transmitting optical assembly and at least one optical coupler. Third inner optical fibers optically couple receiver optical assembly and at least one optical coupler.

### CROSS-REFERENCE TO RELATED APPLICATIONS

This non-provisional application claims priority under 35 U.S.C. § 119(a) on Patent Application No(s). 113106483 filed in Taiwan, ROC on Feb. 23, 2024, the entire contents of which are hereby incorporated by reference.

### BACKGROUND

### 1. Technical Field

This disclosure relates to an optical module, particularly to an optical module including a transmitting optical assembly and a receiver optical assembly.

### 2. Related Art

Co-Packaged Optics (CPO) technology provides a configuration in which an electronic integrated circuit (EIC) and a photonic integrated circuit (PIC) are mounted on a carrier. CPO technology enables optical communication assemblies to be located closer to processing chips, solving the challenges presented by small pluggable optical transceivers, including thermal management, power consumption, bandwidth, and the density of connecting ports.

However, CPO technology still presents some problems to be solved in the application of existing optical modules.

### SUMMARY

According to one aspect of the present disclosure, an optical module disclosed by present disclosure includes a housing, at least one optical coupler, a motherboard, a daughter board, a first transmitting optical assembly, a second transmitting optical assembly, a receiver optical assembly, at least one first inner optical fiber, at least one second inner optical fiber, and a plurality of third inner optical fibers. The optical coupler is disposed within an accommodation space defined by the housing. The motherboard is disposed in the housing. The daughter board is disposed in the housing and is disposed on a mounting surface of the motherboard. The first transmitting optical assembly is disposed on the mounting surface of the motherboard. The second transmitting optical assembly is disposed on a mounting surface of the daughter board, and the mounting surface of the daughter board and the mounting surface of the motherboard face identical direction. The receiver optical assembly is disposed on the mounting surface of the motherboard. The first inner optical fiber optically couples the first transmitting optical assembly and the optical coupler. The second inner optical fiber optically couples the second transmitting optical assembly and the optical coupler. The plurality of third inner optical fibers optically couple the receiver optical assembly and the optical coupler.

According to another aspect of the present disclosure, an optical module disclosed by present disclosure includes a motherboard, a daughter board, a first transmitting optical assembly, a second transmitting optical assembly, a receiver optical assembly, an upper cover, a top cover, at least one first inner optical fiber, at least one second inner optical fiber, and a bending fiber array. The daughter board is disposed on a mounting surface of the motherboard. The first transmitting optical assembly is disposed on the mounting surface of the motherboard. The second transmitting optical assembly is disposed on a mounting surface of the daughter board, and the mounting surface of the daughter board and the mounting surface of the motherboard face identical direction. The receiver optical assembly is disposed on the mounting surface of the motherboard. The upper cover is disposed above the first transmitting optical assembly. The top cover is disposed above the second transmitting optical assembly. The first inner optical fiber is optically coupled to the first transmitting optical assembly. The second inner optical fiber is optically coupled to the second transmitting optical assembly, and the second inner optical fiber crosses the upper cover. The bending fiber array includes a plurality of third inner optical fibers optically coupled to the receiver optical assembly, and the plurality of third inner optical fibers cross the top cover.

According to still another aspect of the present disclosure, an optical module includes a motherboard, a daughter board, a transmitting optical assembly, a receiver optical assembly, a top cover, at least one inner optical fiber, and a bending fiber array. The daughter board is disposed on a mounting surface of the motherboard. The transmitting optical assembly is disposed on a mounting surface of the daughter board, and the mounting surface of the daughter board and the mounting surface of the motherboard face identical direction. The receiver optical assembly is disposed on the mounting surface of the motherboard. The top cover is disposed above the transmitting optical assembly. The bending fiber array includes a plurality of inner optical fibers optically coupled to the receiver optical assembly, and the plurality of inner optical fibers cross the top cover.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is a perspective view of an optical module according to one embodiment of the present disclosure;

FIG. 2 is a perspective view of components inside the optical module in FIG. 1;

FIG. 3 is an exploded view of the components inside the optical module in FIG. 2;

FIG. 4 is a side view of the components inside the optical module in FIG. 2;

FIG. 5 is a partially enlarged view of the components inside the optical module in FIG. 2;

FIG. 6 is another partially enlarged view of the components inside the optical module in FIG. 2;

FIG. 7 is still another partially enlarged view of the components inside the optical module in FIG. 2;

FIG. 8 is a cross-sectional view of the components inside the optical module in FIG. 7;

FIG. 9 and FIG. 10 are schematic views showing the formation of the recesses of the motherboard in FIG. 8; and

FIG. 11 is a schematic view of an optical communication system according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

With the increasing demand for higher transmission rates such as 1.6 Tbps, 3.2 Tbps, or even 6.4 Tbps, CPO technology is regarded as a promising solution and draws significant attention. Currently, Optical Internetworking Forum (OIF) has defined a Co-Packaging Framework for CPO to facilitate the compatibility of optical internet products all over the world. In compliance with Co-Packaging Framework defined by OIF, one of the current problems to be solved in the relevant industry is to provide optical modules that can be configured with more active components or passive components associated with optical communication.

According to an optical module in one embodiment of the present disclosure, a first transmitting optical assembly is disposed on a mounting surface of a motherboard, and a second transmitting optical assembly is disposed on a mounting surface of a daughter board. The second transmitting optical assembly and the first transmitting optical assembly disposed on the motherboard are located at different heights from a certain reference level (i.e., there is a height difference between them). Besides, a bending fiber array optically coupled to a receiver optical assembly allows an optical fiber to cross the first transmitting optical assembly and the second transmitting optical assembly, so that the receiver optical assembly can be disposed on the motherboard together with the first transmitting optical assembly. It is worth noting that both of the receiver optical assembly and the first transmitting optical assembly may be located on two opposite sides of the daughter board, respectively. In this way, the arrangement of optical communication assemblies at multiple positions along a lengthwise direction of the optical module could be realized, rendering feasible compact arrangement of the optical module.

According to the optical module in one embodiment of the present disclosure, the upper cover disposed above the first transmitting optical assembly and the top cover disposed above the second transmitting optical assembly prevent the optical fibers from interfering with each other For example, the upper cover prevents the second inner optical fiber from interfering with the first inner optical fiber associated with the first transmitting optical assembly, and the top cover prevents the third inner optical fiber from interfering with the second inner optical fiber associated with the optical transmission of the second transmitting optical assembly.

Some or all of the technical features disclosed in one or more embodiments of the present disclosure may be combined to achieve corresponding effects.

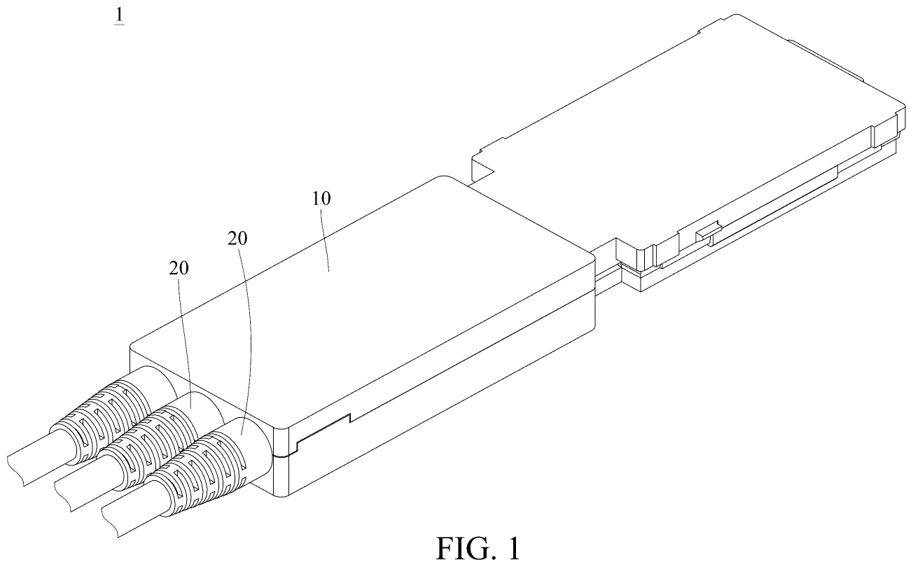

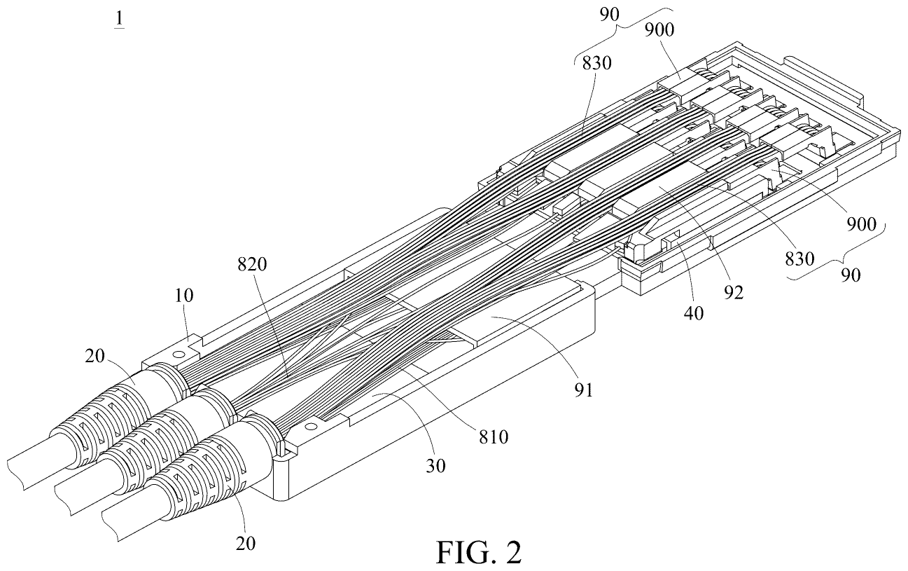

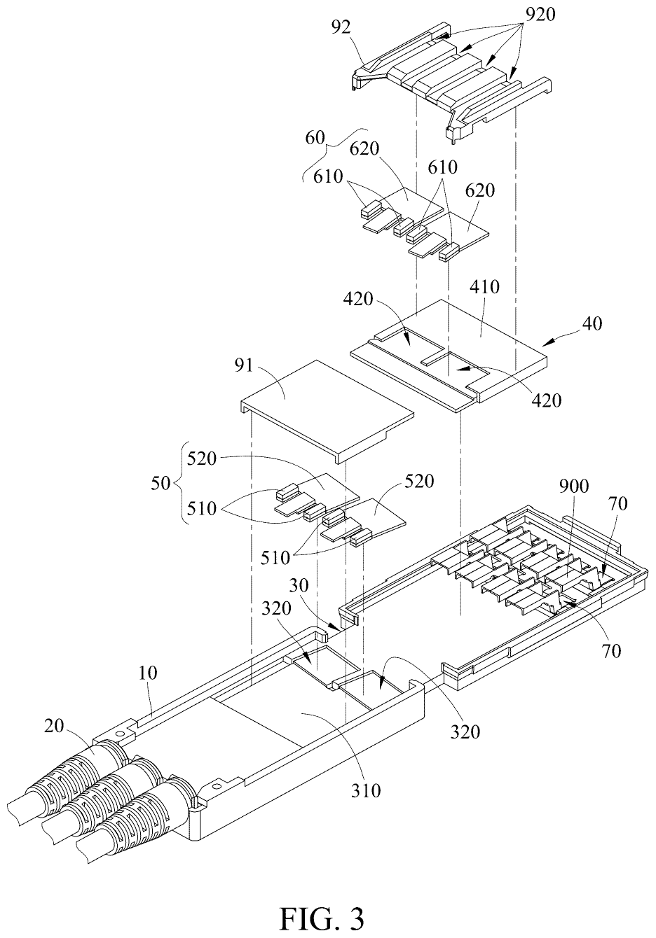

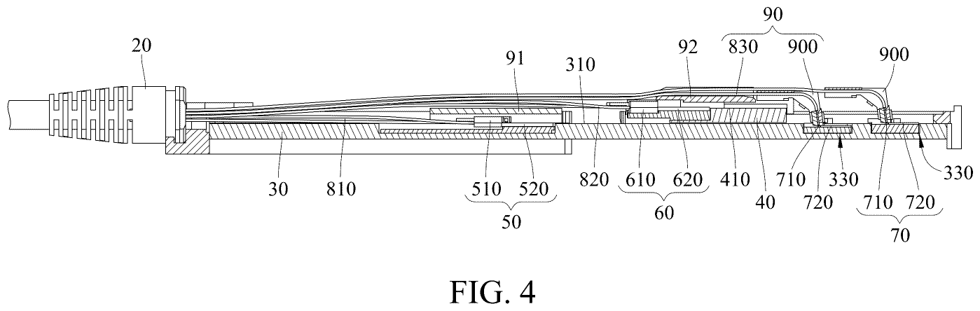

Please refer to FIGS. 1 to 4. FIG. 1 is a perspective view of an optical module 1 according to one embodiment of the present disclosure, FIG. 2 is a perspective view of components inside the optical module 1 in FIG. 1, FIG. 3 is an exploded view of the components inside the optical module 1 in FIG. 2, and FIG. 4 is a side view of the component inside the optical module 1 in FIG. 2. In this embodiment, the optical module 1 may include a housing 10, multiple optical couplers 20, a motherboard 30, a daughter board 40, a first transmitting optical assembly 50, a second transmitting optical assembly 60, a receiver optical assembly 70, and a plurality of inner optical fibers. For the illustration, the inner optical fibers are omitted from FIG. 3. The optical module 1 may be understood as an optical transceiver.

The housing 10 may be a housing suitable for Co-Packaging Framework defined by OIF.

The optical coupler 20 may be disposed within an accommodation space defined by the housing 10, with at least a part of the optical coupler 20 extending out of the accommodation space. One end of the inner optical fiber may be coupled to the optical coupler 20. FIGS. 1 to 4 exemplarily illustrate that the optical module 1 includes three optical couplers 20, but the number of the optical coupler 20 is not intended to limit the present disclosure. The optical coupler 20 may be understood as an optical fiber connector or an active optical cable (AOC).

For example, the motherboard 30 may be a Printed Circuit Board Assembly (PCBA), and the daughter board 40 may be another PCBA. The motherboard 30 and the daughter board 40 may be disposed in the housing 10, and the daughter board 40 may be disposed on a mounting surface 310 of the motherboard 30. More specifically, the daughter board 40 may be fixed to the mounting surface 310 of the motherboard 30 to realize the electrical connection between circuits of the daughter board 40 and circuits of the motherboard 30. Besides, the daughter board 40 may have a mounting surface 410, which may face identical direction with the mounting surface 310. In one embodiment, the mounting surface 310 may be a top surface of the motherboard 30. In one embodiment, the mounting surface 410 may be a top surface of the daughter board 40. In one embodiment, both the mounting surfaces 310 and 410 face upward.

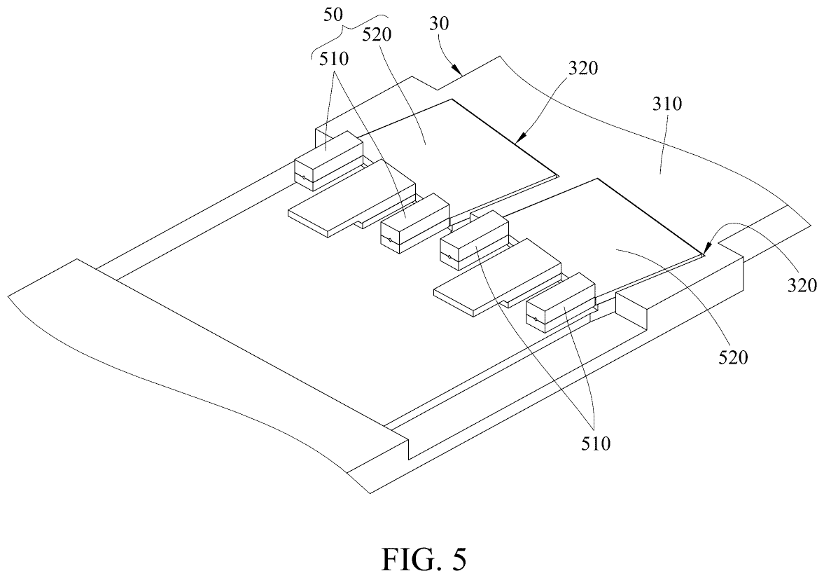

The first transmitting optical assembly 50 may be disposed on the mounting surface 310 of the motherboard 30. Further, please refer to FIG. 5. FIG. 5 is a partially enlarged view of the components inside the optical module 1 in FIG. 2. As with FIG. 3, the inner optical fibers are omitted from FIG. 5 for the illustration purpose. The first transmitting optical assembly 50 may include a transmitting optical unit 510 and an electronic component 520. For example, the transmitting optical unit 510 may be a laser diode, and the electronic component 520 may be a driving chip. Further, the electronic component 520 may be understood as a PIC. The first transmitting optical assembly 50 may further include an optical modulator, a wavelength division multiplexer, a collimating lens and/or a digital signal processor (DSP). FIG. 5 exemplarily illustrates two first transmitting optical assemblies 50, and each of the first transmitting optical assemblies 50 includes two transmitting optical units 510. However, the number of the first transmitting optical assemblies 50 is not intended to limit the present disclosure.

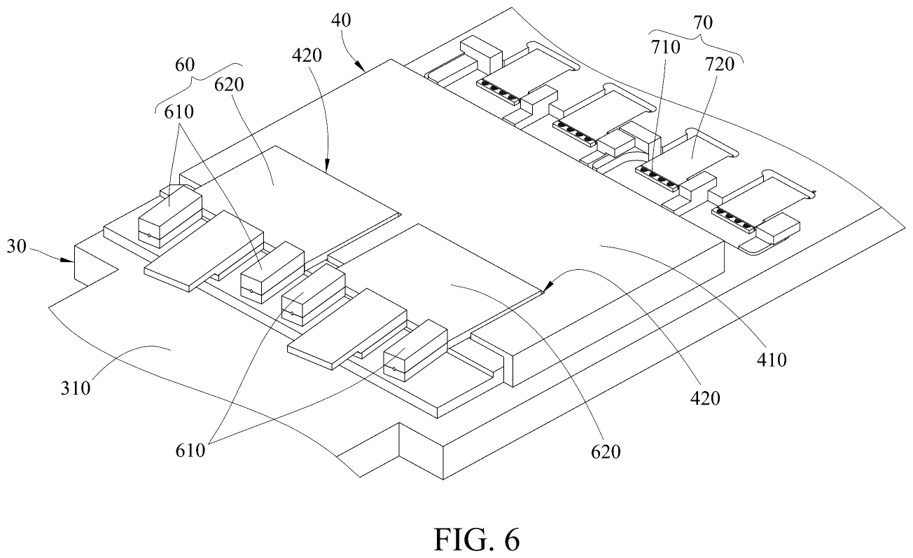

The second transmitting optical assembly 60 may be disposed on the mounting surface 410 of the daughter board 40. Further, please refer to FIG. 6. FIG. 6 is another partially enlarged view of the components inside the optical module 1 in FIG. 2. The inner optical fibers are omitted from FIG. 6 for the illustration purpose as well. The second transmitting optical assembly 60 may include a transmitting optical unit 610 and an electronic component 620. For example, the transmitting optical unit 610 may be a laser diode, and the electronic component 620 may be a driving chip. Further, the electronic component 620 may be understood as a PIC. The second transmitting optical assembly 60 may further include an optical modulator, a wavelength division multiplexer, a collimating lens and/or a DSP. FIG. 6 exemplarily illustrates two second transmitting optical assemblies 60, and each of the second transmitting optical assemblies 60 includes two transmitting optical units 610. However, the number of the second transmitting optical assemblies 60 is not intended to limit the present disclosure

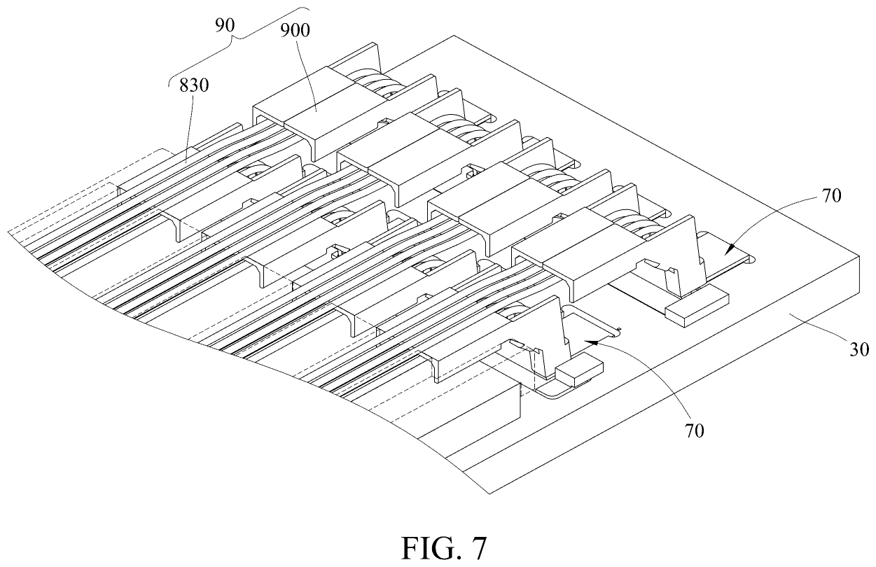

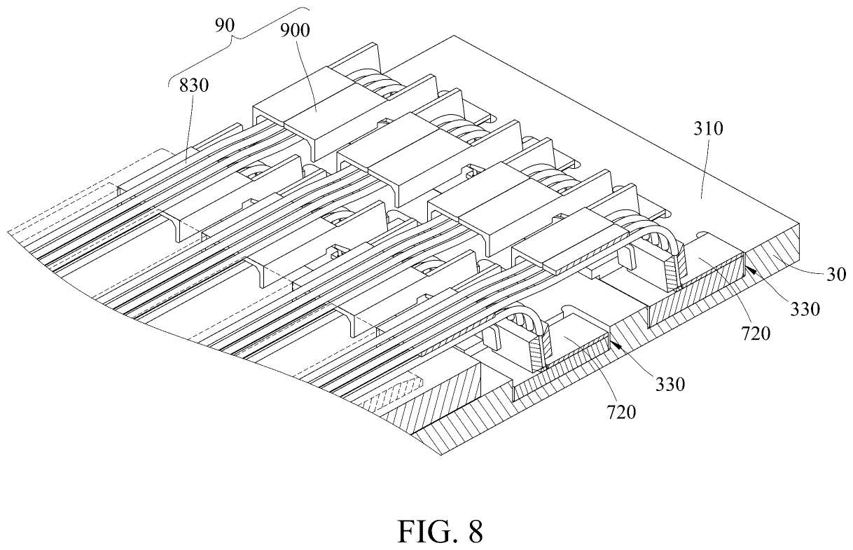

The receiver optical assembly 70 may be disposed on the mounting surface 310 of the motherboard 30. Further, please refer to FIGS. 6 to 8. FIG. 7 is still another partially enlarged view of the components inside the optical module 1 in FIG. 2, and FIG. 8 is a cross-sectional view of the components inside the optical module 1 in FIG. 7. The receiver optical assembly 70 may include an optical receiving unit 710 and an electronic component 720. For example, the optical receiving unit 710 may be a photodiode, and the electronic component 720 may be a transimpedance amplifier. Further, the electronic component 720 may be understood as an EIC. The receiver optical assembly 70 may further include a wavelength division demultiplexer and/or a DSP. FIG. 7 and FIG. 8 exemplarily illustrate eight receiver optical assemblies 70, and each of the receiver optical assemblies 70 includes four optical receiving units 710. However, the number of the receiver optical assemblies 70 is not intended to limit the present disclosure. Besides, FIG. 7 and FIG. 8 also illustrate eight receiver optical assemblies 70 arranged in two rows with four receiver optical assemblies 70 arranged in each row, but the present disclosure is not limited thereto.

The inner optical fiber may include a first inner optical fiber 810 optically coupling the first transmitting optical assembly 50 and the optical coupler 20, a second inner optical fiber 820 optically coupling the second transmitting optical assembly 60 and another optical coupler 20, and a third inner optical fiber 830 optically coupling the receiver optical assembly 70 and another optical coupler 20. Optical signals generated by the first transmitting optical assembly 50 may be transmitted to an external optical fiber via the first inner optical fiber 810 and the optical coupler 20. The optical signals generated by the second transmitting optical assembly 60 may be transmitted to the external optical fiber via the second inner optical fiber 820 and the corresponding optical coupler 20. The optical signals transmitted by external optical fiber may be received by the receiver optical assembly 70 via the corresponding optical coupler 20 and the third inner optical fiber 830. FIG. 2 exemplarily illustrates four first inner optical fibers 810, four second inner optical fibers 820, and eight third inner optical fibers 830, and the third inner optical fiber 830 may be a ribbon fiber optic cable. However, the number of the optical fibers is not intended to limit the present disclosure.

In some embodiments, the first transmitting optical assembly 50 and the second transmitting optical assembly 60 may be understood as a Transmitting Optical Sub-Assembly (TOSA), and the receiver optical assembly 70 may be understood as a Receiver Optical Sub-Assembly (ROSA).

According to one embodiment of the present disclosure, the second transmitting optical assembly 60 may be of a different height from those of the first transmitting optical assembly 50 and the receiver optical assembly 70. As shown in FIG. 4, the first transmitting optical assembly 50 and the receiver optical assembly 70 are located lower than the second transmitting optical assembly, which is disposed on the mounting surface 410 of the daughter board 40, when they are disposed on the mounting surface 310 of the motherboard 30.

According to one embodiment of the present disclosure, the third inner optical fiber 830 may be included in a bending fiber array, and the bending fiber array may be optically coupled to the receiver optical assembly 70. As shown in FIG. 7 and FIG. 8, the bending fiber array 90 may include a supporting base 900 and a third inner optical fiber 830. The supporting base 900 accommodates the third inner optical fiber 830 and effectively bends the third inner optical fiber 830.

According to one embodiment of the present disclosure, the second transmitting optical assembly 60 may be located farther away from the corresponding optical coupler 20 than the first transmitting optical assembly 50, and the receiver optical assembly 70 may be located farther away from the corresponding optical coupler 20 than the second transmitting optical assembly 60. More specifically, the first transmitting optical assembly 50, the second transmitting optical assembly 60, and the receiver optical assembly 70 are sequentially arranged along the lengthwise direction of the optical module 1.

Because the second transmitting optical assembly 60 is disposed on the daughter board 40, the second transmitting optical assembly 60 and the first transmitting optical assembly 50 of the disposed motherboard 30 may be of different heights from a certain reference level (for example, from the bottom of the housing 10). Besides, the bending fiber array 90 optically coupled to the receiver optical assembly 70 allows the optical fiber to cross the first transmitting optical assembly 50 and the second transmitting optical assembly 60, so that the receiver optical assembly 70 may be disposed on the motherboard 30 together with the first transmitting optical assembly 50, and both of the receiver optical assembly 70 and the first transmitting optical assembly 50 may be in a space above the motherboard 30 and located on two opposite sides of the daughter board 40, respectively. In this way, the arrangement of optical communication assemblies at multiple positions could be realized along a lengthwise direction of the optical module 1 without being arranged along a widthwise direction of the optical module 1, thereby rendering possible the compact arrangement of the optical module 1.

According to one embodiment of the present disclosure, the optical module 1 may further include an upper cover 91 disposed above the first transmitting optical assembly 50. As shown in FIG. 2, the second inner optical fiber 820 crosses the upper cover 91 to be optically coupled to the second transmitting optical assembly 60. Besides, the optical module 1 may also include a top cover 92 disposed above the second transmitting optical assembly 60. As shown in FIG. 2, the third inner optical fiber 830 crosses top cover 92 to be optically coupled to the receiver optical assembly 70. The upper cover 91 and the top cover 92 prevent the optical fibers from interfering with each other. For example, the upper cover 91 may prevent the second inner optical fiber 820 from interfering with the first inner optical fiber 810 associated with the first transmitting optical assembly 50, and the top cover 92 may prevent the third inner optical fiber 830 from interfering with the second inner optical fiber associated with the second transmitting optical assembly 60.

According to one embodiment of the present disclosure, the top cover 92 may have a groove 920. As shown in FIG. 2 and FIG. 3, the third inner optical fiber 830 is disposed in the groove 920. FIG. 3 exemplarily illustrates that the top cover 92 has four grooves 920 accommodating four third inner optical fibers 830 that are ribbon fiber optic cables, respectively. However, the number of the groove 920 is not intended to limit the present disclosure.

According to one embodiment of the present disclosure, motherboard 30 may have a recess 320 located on the mounting surface 310. As shown in FIG. 3 and FIG. 5, at least a part of the first transmitting optical assembly 50 may be disposed in the recess 320. More specifically, the electronic component 520 of the first transmitting optical assembly 50 may be disposed in the recess 320.

According to one embodiment of the present disclosure, the daughter board 40 may have a recess 420 located on the mounting surface 410. As shown in FIG. 3 and FIG. 6, at least a part of the second transmitting optical assembly 60 may be disposed in the recess 420. More specifically, the electronic component 620 of the second transmitting optical assembly 60 may be disposed in the recess 420.

According to one embodiment of the present disclosure, the motherboard 30 may have a recess 330 located on the mounting surface 310. As shown in FIG. 4 and FIG. 8, at least a part of the receiver optical assembly 70 may be disposed in the recess 330. More specifically, the electronic component 720 of the receiver optical assembly 70 may be disposed in the recess 330. A depth of the recess 330 may be greater than a half of a thickness of the motherboard 30.

The recesses 320 and 330 and the recess 420 may reduce the length of the wiring, thereby reducing the signal transmission loss between the electronic components.

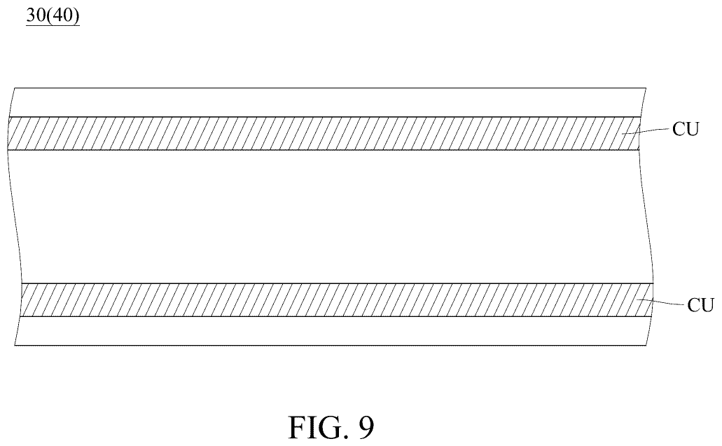

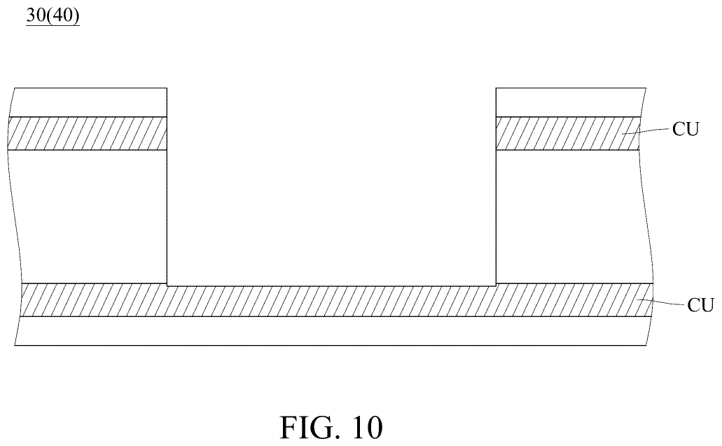

According to one embodiment of the present disclosure, a depth of the recess 320 may be greater than a half of a thickness of the motherboard 30, a depth of the recess 330 may be greater than a half of a thickness of the motherboard 30, and a depth of the recess 420 may be greater than a half of a thickness of the daughter board 40. Further, in a case where all of the substrates (the motherboard 30 or the daughter board 40) have a multi-layer structure, most part of the substrate may be firstly removed through CNC processing, and then a carbon dioxide laser processing is performed to ensure that a copper layer CU in the substrate is exposed to the outside. FIG. 9 and FIG. 10 are schematic views showing the formation of the recesses of the motherboard 30 in FIG. 8.

According to one embodiment of the present disclosure, two of the receiver optical assemblies 70 may be located at different heights. As shown in FIG. 8, the receiver optical assembly 70 located in the front row is disposed on a thinner supporting base, and the receiver optical assembly 70 located in the rear row is disposed on a thicker supporting base. Thus, the receiver optical assembly 70 in the front row may be located lower than the receiver optical assembly 70 in the rear row.

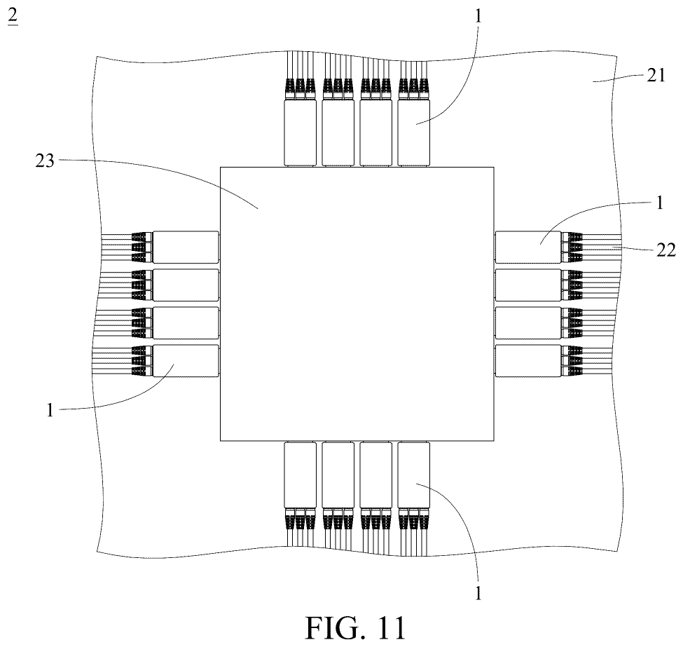

FIG. 11 is a schematic view of an optical communication system 2 according to one embodiment of the present disclosure. The optical communication system 2 may include the optical module 1 as shown in FIG. 1, and the optical module 1 may be fixed on a carrier board 21 including an application-specific integrated circuit (ASIC) chip 23. An optical port of the optical module 1 may be adapted to the external optical fiber 22, and an electrical port of the optical module 1 may be electrically connected to the ASIC chip 23. FIG. 11 exemplarily illustrates that the optical communication system 2 includes a total of sixteen optical modules 1, where each of the optical modules 1 may have a signal transmission rate of 3.2 Tbps, and the ASIC chip 23 may have a signal transmission rate of 51.2 Tbps.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical module, comprising:
a housing;
at least one optical coupler, disposed within an accommodation space defined by the housing;
a motherboard, disposed in the housing;
a daughter board, disposed in the housing and disposed on a mounting surface of the motherboard;
a first transmitting optical assembly, disposed on the mounting surface of the motherboard;
a second transmitting optical assembly, disposed on a mounting surface of the daughter board, wherein the mounting surface of the daughter board and the mounting surface of the motherboard face identical direction;
an receiver optical assembly, disposed on the mounting surface of the motherboard;
at least one first inner optical fiber, optically coupling the first transmitting optical assembly and the at least one optical coupler;
at least one second inner optical fiber, optically coupling the second transmitting optical assembly and the at least one optical coupler; and
a plurality of third inner optical fibers, optically coupling the receiver optical assembly and the at least one optical coupler.

2. The optical module according to claim 1, wherein the optical module comprises Co-Packaged Optics (CPO) configuration.

3. The optical module according to claim 1, wherein the second transmitting optical assembly is of a different height from those of the first transmitting optical assembly and the receiver optical assembly.

4. The optical module according to claim 1, wherein a bending fiber array comprises the plurality of third inner optical fibers, and the bending fiber array is optically coupled to the receiver optical assembly.

5. The optical module according to claim 1, wherein the second transmitting optical assembly is located farther away from the at least one optical coupler than the first transmitting optical assembly, and the receiver optical assembly is located farther away from the at least one optical coupler than the second transmitting optical assembly.

6. The optical module according to claim 1, wherein the motherboard has a recess located on the mounting surface, at least a part of the first transmitting optical assembly is disposed in the recess, and a depth of the recess is greater than half of a thickness of the motherboard.

7. The optical module according to claim 1, further comprising an upper cover disposed above the first transmitting optical assembly, wherein the at least one second inner optical fiber crosses the upper cover.

8. The optical module according to claim 1, wherein the daughter board has a recess located on the mounting surface, at least a part of the second transmitting optical assembly is disposed in the recess, and a depth of the recess is greater than half of a thickness of the daughter board.

9. The optical module according to claim 1, further comprising a top cover disposed above the second transmitting optical assembly, wherein the plurality of third inner optical fibers cross the top cover.

10. The optical module according to claim 9, wherein the top cover has a groove, and the plurality of third inner optical fibers are disposed in the groove.

11. The optical module according to claim 1, wherein the motherboard has a recess located on the mounting surface, at least a part of the receiver optical assembly is disposed in the recess, and a depth of the recess is greater than half of a thickness of the motherboard.

12. An optical module, comprising:
a motherboard;
a daughter board, disposed on a mounting surface of the motherboard;
a first transmitting optical assembly, disposed on the mounting surface of the motherboard;
a second transmitting optical assembly, disposed on a mounting surface of the daughter board, wherein the mounting surface of the daughter board and the mounting surface of the motherboard face identical direction;
an receiver optical assembly, disposed on the mounting surface of the motherboard;
an upper cover, disposed above the first transmitting optical assembly;
a top cover, disposed above the second transmitting optical assembly;
at least one first inner optical fiber, optically coupled to the first transmitting optical assembly;
at least one second inner optical fiber, optically coupled to the second transmitting optical assembly, wherein the at least one second inner optical fiber crosses the upper cover; and
a bending fiber array, comprising a plurality of third inner optical fibers optically coupled to the receiver optical assembly, wherein the plurality of third inner optical fibers cross the top cover.

13. The optical module according to claim 12, wherein the optical module is based on CPO configuration.

14. The optical module according to claim 12, wherein the second transmitting optical assembly is of a different height from those of the first transmitting optical assembly and the receiver optical assembly.

15. The optical module according to claim 12, wherein the motherboard has a recess located on the mounting surface, at least a part of the first transmitting optical assembly is disposed in the recess, and a depth of the recess is greater than half of a thickness of the motherboard.

16. The optical module according to claim 12, wherein the daughter board has a recess located on the mounting surface, at least a part of the second transmitting optical assembly is disposed in the recess, and a depth of the recess is greater than half of a thickness of the daughter board.

17. The optical module according to claim 12, wherein the top cover has a groove, and the plurality of third inner optical fibers are disposed in the groove.

18. The optical module according to claim 12, wherein the motherboard has a recess located on the mounting surface, at least a part of the receiver optical assembly is disposed in the recess, and a depth of the recess is greater than half of a thickness of the motherboard.

19. An optical module, comprising:
a motherboard;
a daughter board, disposed on a mounting surface of the motherboard;
a transmitting optical assembly, disposed on a mounting surface of the daughter board, wherein the mounting surface of the daughter board and the mounting surface of the motherboard face identical direction;
an receiver optical assembly, disposed on the mounting surface of the motherboard;
a top cover, disposed above the transmitting optical assembly; and
a bending fiber array, comprising a plurality of inner optical fibers optically coupled to the receiver optical assembly, wherein the plurality of inner optical fibers cross the top cover.

20. The optical module according to claim 19, wherein the top cover has a groove, and the plurality of inner optical fibers are disposed in the groove.
